(19) United States
(12) Patent Application Publication
(10) Pub. No.: US 2020/0065348 A1
(43) Pub. Date: Feb. 27, 2020

(54) METHOD FOR AUTOMATICALLY INSERTING KEYWORDS FOR SEARCHING A CERTAIN OF CONTENTS WITH SPECIAL IDENTIFIER CODE

(71) Applicant: NDSOFT Co., Ltd., Busan (KR)

(72) Inventor: Namdo PARK, Busan (KR)

(73) Assignee: NDSOFT Co., Ltd.

(21) Appl. No.: 16/551,695

(22) Filed: Aug. 26, 2019

(30) Foreign Application Priority Data
Aug. 27, 2018 (KR) 10-2018-0100371

(51) Int. Cl. G06F 16/9536; G06F 3/0482; G06F 17/21; G06F 16/9035; G06F 16/9032

(52) U.S. Cl. CPC G06F 16/9536; G06F 3/0482; G06F 16/90332; G06F 16/9035; G06F 17/218

(57) ABSTRACT

Provided is a method for automatically inserting search keyword to content including: transmitting a first content from the server to a search engine; searching a second content having a predetermined degree of similarity to the first content; extracting and copying a first text from the second content and storing the first text in the server, generating, in the first server, a first txt file for the first text; arranging first words line by line using a margin to generate a second text; removing one or more duplicate word from second words included in the second text and attaching a special identifier to each of remaining second words to generate a third text; and response to transmission of the third text from the server to the application, displaying the first content integrated with the third text on the user terminal.

### CROSS-REFERENCE TO RELATED APPLICATION

This application claims the benefit of and priority to Korean Patent Application No. 10-2018-0100371 filed on Aug. 27, 2018, which are herein incorporated by reference in its entirety.

### TECHNICAL FIELD

The present invention relates to a method for automatically inserting keywords for searching a certain of contents with a hashtag. More specifically, the present invention provides an application or system capable to automatically extract words from a search engine. The extracted words and hashtags are automatically attached to a content, thereby increasing a chance of exposure to search. Duplicate words and unwanted words can be removed. Desired words can be added.

### BACKGROUND OF INVENTION

Recently, people want to expand their online relationships with others by posting various kinds of content such as texts and pictures (image on social media, bragging to unspecified people or letting them know about their recent events.

As well-known, when uploading content such as pictures, texts, photos, videos, etc. on an application or an internet website, people attach a short phrase describing the content. For example, if the content is a picture, a variety of notes or wordings such as mood, weather, location, place, etc. at the time of taking the picture can he attached to the content. A hashtag is also attached to the content to make the picture searchable by other people.

Special identifiers, such as hashtags, are entered in the following manner, making the content searchable by others.

# 2018, #How is it Going Today?, #1 like this Place, # Working Right Now

The more hashtags are attached to the content, the easierly searchable is the content and the more exposable to people. Thus, people try to enter various words as hashtags to make the content easily exposable and searchable. However, it is not easy to select an descriptive phrase or word appropriate to a specific content, Even if an appropriate phrase or is found, it can be cumbersome to manually enter each phrase or word one by one.

For this reason, it is not uncommon people upload the content without attaching any phrases or words that might facilitate exposure of the content upon search. However, if this situation persists, a large amount of content would escape from search and remain hidden. Since this is contrary to a user's intention of sharing their contents with other people, there is a need to solve this problem.

Related prior art Korean Patent Publication No. 1020160158308 entitled “A hash tag insertion method using image recognition and a software distribution server storing software for performing the method”

### DETAILED DESCRIPTION

### Problems to be Solved

The present invention is proposed to solve the conventional problems described above. An objective of the present invention is to provide a method for automatically inserting search keywords along with a hashtag to content. Then, the content is uploaded on social media etc.

### Solution to Solve the Problems

In an embodiment of the present invention, a method is provided of: extracting a thumbnail of a first picture from a server; searching for a second picture similar or identical to the first picture from a search portal or an online search engine; extracting the words or phrases attached to the second picture; and automatically attaching the words or phrases to the first picture along with a special identifiers “#” as a hashtag. Then, the first picture is uploaded. Due to the attached words, the first picture can be easily searched and exposed to other people.

According to an embodiment of the present invention, a method for automatically inserting keywords for searching a certain of contents with a hashtag includes: in response to transmission of a first content from a user terminal to a server via an application, transmitting the first content from the server to a search engine, wherein the application is installed on the user terminal and linked with the server; searching a second content using the search engine, wherein the second content has a predetermined degree of similarity to the first content, wherein the number of the second content is one or more: extracting and copying a first text from the second content and storing the first text in the server; generating, in the first server, a first txt file corresponding to the first text; arranging first words, which are included in the first text, line by line sing a margin to generate a second text, wherein the number of first words is one or more; removing a duplicate word from second words and attaching a special identifier to each of the remaining second words to generate a third text and in response to transmission of the third text from the server to the application installed on the user terminal, displaying the first content integrated with the third text on the user terminal.

In an embodiment of the present invention, the method may further include adding a word desired by a user along with the hashtag.

### Advantages of the Invention

According to an embodiment of the present invention, appropriate search keywords, along with a hashtag, can be automatically attached to a given content. The given content may be a picture. Thereby, a chance of exposure of the content increases. The search keywords can be borrowed from phrases or words that were already used and popular to describe the content on search engines. In addition, specific phrases or words can be added when the user desires.

### BRIEF DESCRIPTION OF DRAWINGS

FIG. 1 is a system according to an embodiment of the present invention,

FIG. 2 is a screenshot showing a first image, wherein the first image is selected on an application installed on a user terminal according to an embodiment of the present invention.

FIG. 3 is a screenshot showing the first image and a list of texts and hashtags, wherein the first image is ready to be uploaded, where the list of texts and hashtags may be attached to the first image.

FIG. 4 is a screenshot showing a search result obtained from a search engine.

FIG. 5 is another screenshot showing the search result obtained in FIG. 4.

FIG. 6 is a screenshot showing a first txt file created in a server according to an embodiment of the present invention.

FIG. 7 is a screenshot showing a first text included in the first txt file,

FIG. 8 is a screenshot showing a second text which is obtained by arranging the first text.

FIG. 9 is a screenshot showing a third text which is obtained by integrating the second text with a hashtag.

FIG. 10 is a screen showing a third image which is automatically generated by integrating the first image with the third text.

### EMBODIMENTS

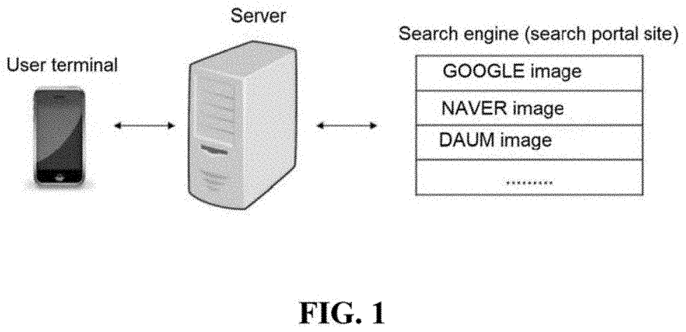

Hereinafter, the present invention will be described in more detail with reference to the accompanying drawings. FIG. 1 is a system according to are embodiment of the present invention. As shown in drawings, (i) a user terminal such as a smartphone, a predetermined application (not shown) installed on the user terminal, (ii) a server that can be linked to the application, and (iii) a search engine that can exchange information, with the server (e.g., Google, Naver, Daum, etc.) etc may be necessary to implement the method according to the present invention.

According to an embodiment of the present invention, the method can be performed on an application which is installed on a user terminal. The search engine linked with the server may be a website that receives a first content from the server and searches a second content similar to the first content.

When the first content provided by the server is a picture, the search engine may be an image search engine provided by a search portal company such as Google, Naver, Daum, or the like. Hereinafter, the method of implementing the present invention will be described step by step. In an embodiment, a method for automatically inserting search keywords into a first content along with a hashtag may be designed as follows. First, an application is installed on a user terminal such as a smartphone.

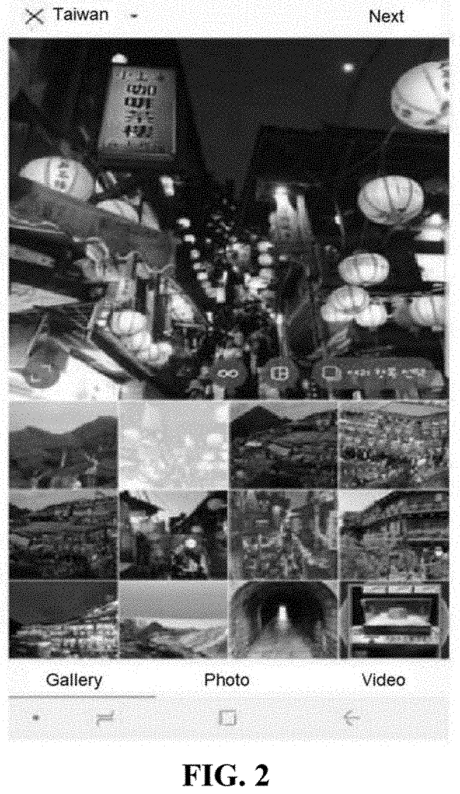

FIG. 2 is a screenshot showing the first image. The first image is selected on the application installed on the user terminal. The application may have a content sharing function, for example, a function of sharing pictures. The application will be described in detail below. In an embodiment, first, the application is activated. The first content may be a photo stored in the user tern anal or a photo directly taken by the user. The first content is selected, e. g., through a touch input method.

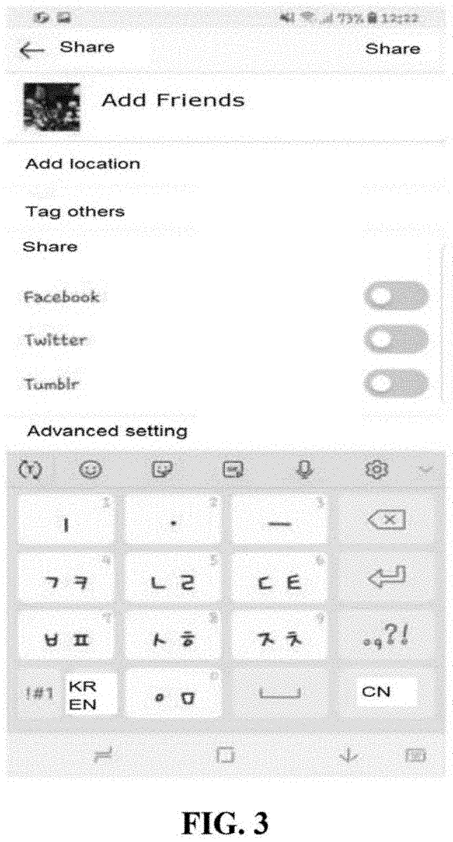

FIG. 3 is a screenshot showing the first content (or the first image) and a list of texts. The first image may be uploaded. The list of texts may be attached to the first image. Next, the first content (or the first image) is transmitted to a server. The server is linked with the application installed on the user terminal. The server receives the first content from the application and stores the first content in the server. In an embodiment, the server may convert and store the first content into a thumbnail.

Next, the server is connected to a search engine provided by a search portal or a search company. The search company may be, for example, Google, Naver, Daum, etc. The server accesses to the search engine and searches for pictures and videos using a programming function such as shown in Table 1 below.

TABLE 1
″ $service_port = ″; ″
ConnectionPORT
″ $address = ′111.333.111.333′; ″
Target client (connects to a specific search engine)
″ $socket = socket_create(AF_INET, SOCK_STREAM, SOL_TCP); ″
Socket creation
″ $result = socket_connect($socket, $address, $service_port); ″
Socket connection
″ $result = socket_write($socket, $fr, strlen($fr)); ″
Sending Images to Search

The server transmits the first content to the search engine provided by a search portal or a search company. The search company may be, for example, Google, Naver, Daum, etc. The search engine may be, e.g., an image search engine. The first content may be, e.g., a thumbnail. The thumbnail may be obtained by convertingthe first content. The search engine searches for at least one or more second content. The seond content has a predetermined similarity to the first content received from the server.

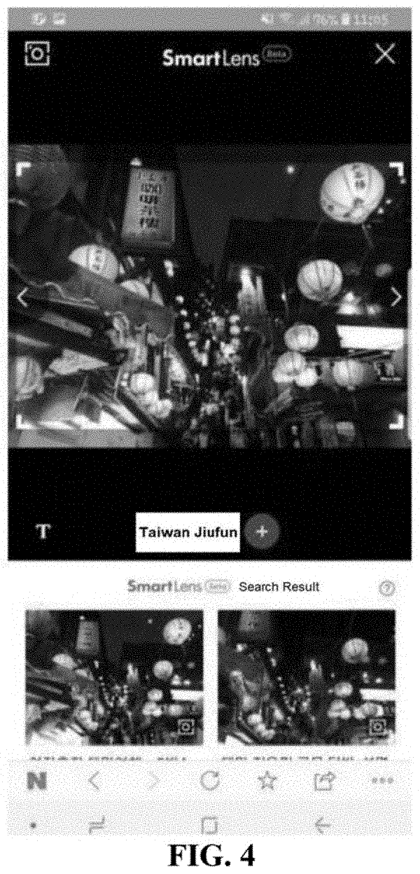

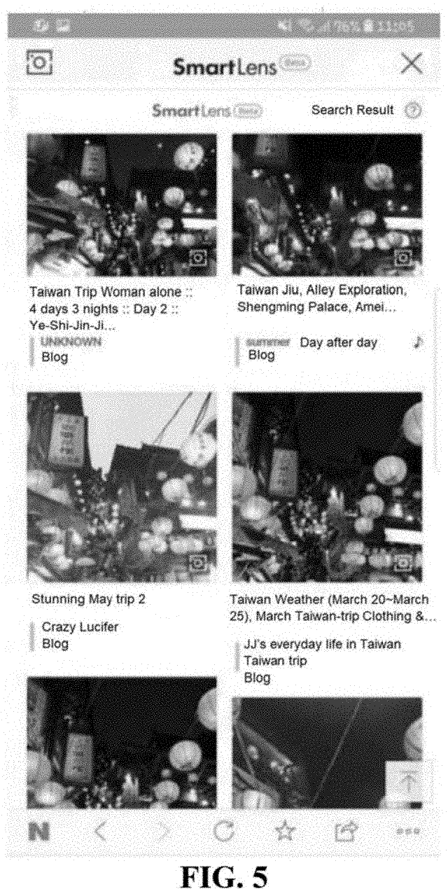

FIG. 4 is a screenshot showing a search result obtained from the search engine. FIG. 5 is another screenshot showing the search result obtained in FIG. 4. In an embodiment, the search engine may designed to provide or not to provide the search result to the user terminal. In addition, the search result may vary depending on search algorithms employed by the search engine.

As is known, the second content retrieved upon the search may have strings such as phrases, words, and the like that describe the second content. The number of the retrieved second content may be one or more. See FIG. 5. Usually, the phrases or words describe the second content, are referred to as “first words” and collectively referred to as “a first text.”

In an embodiment, the server extracts and copies the first text attached to the second content and receives and stores the first text in the server. In an embodiment, the number of first words included in the first text extracted from the second content may be one or more. Upon search, the system may be designed to display a limited number of first words. In an embodiment, the first text may be extracted from the server shown in Table 2 below.

TABLE 2
The first text is extracted from a search result screen.
The extraction is made as follows.
1. On the search result screen: extract and copy the first text using the
programming function ″file_get_contents ()″.
The copied first text can be temporarily stored in a server cache memory.
2. The server creates and opens a first txt file using the following programming
function: ″$txtFile = fopen(″time_user ID_number of times created″, ″w″) or
die(″Unable to open file!″);″
The file name can be ″time _user ID_number of times created″.
Ex) 201808011100_pndpndpnd_123.txt
3. Paste the first text, which is extracted and copied from the step 1, into the first
txt file using the programming function ″ fwrite($myfile, $html);″
4. Use the programming function ″ fclose($myfile); ″ to close the first txt file. As
such, the server converts the first text into the first txt file.

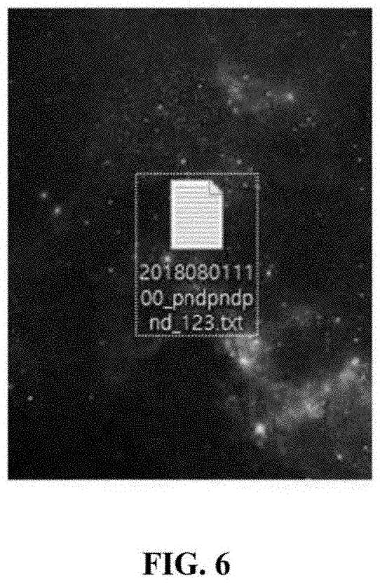

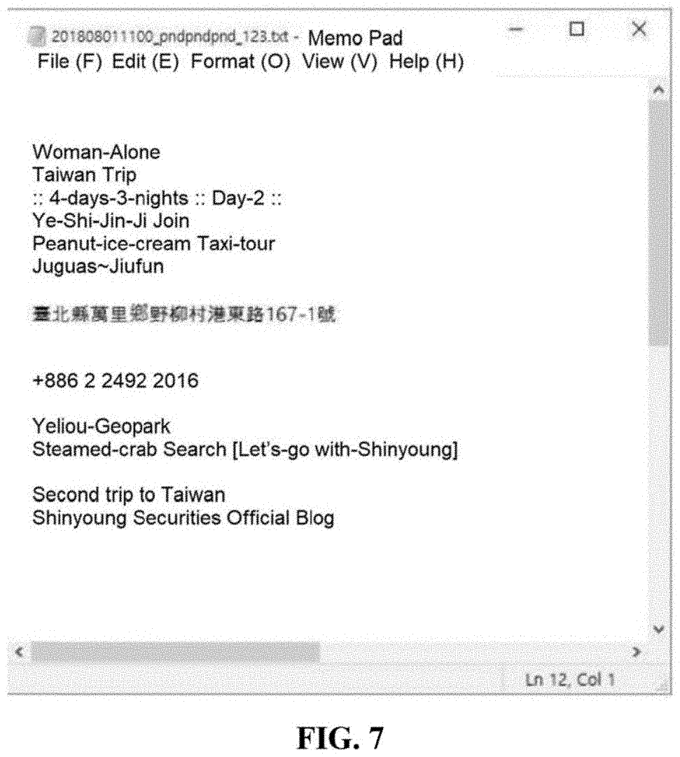

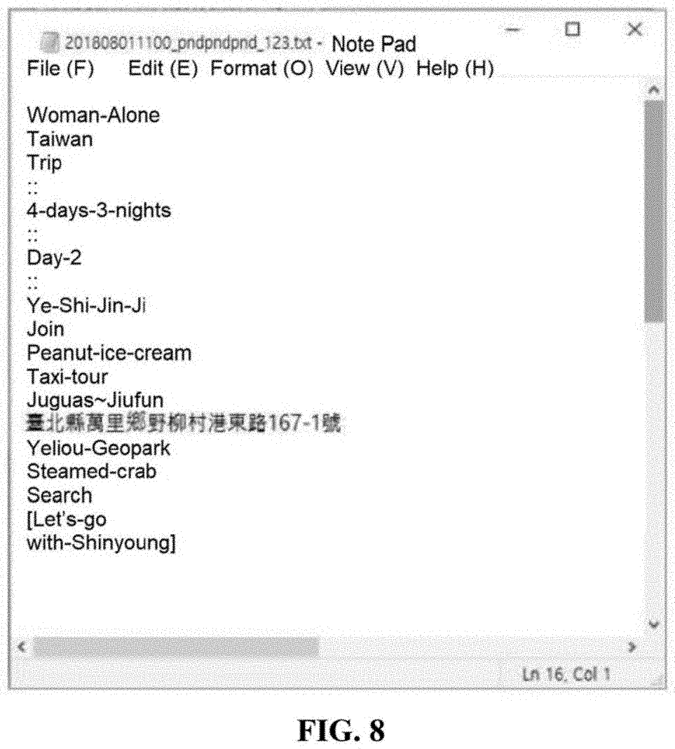

FIG. 6 is a screenshot showing the first txt file created in the sewer. FIG. 7 is a screenshot showing the first text included in the first txt file. FIG. 8 is a screenshot showing a second text which is obtained by arranging the first text. The reason for converting the first text into the first txt file is to perform the following operations.

First, the server arranges the first words included in the first text line by line using a margin between the first words. The number of first words is one or more. See FIG. 8. The arranged first words are referred to second words. The second words collectively form the second text. The number of first words is one or more. See FIG. 8.

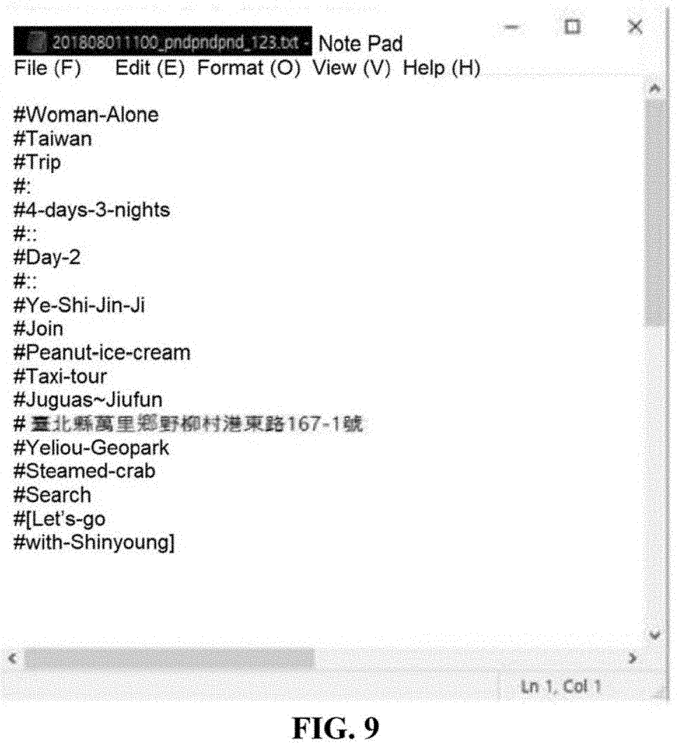

Next, the server removes duplicate words from the secod words. Then, a hashtag is attached in front of each of the second words. The second words integrated with the hashtags are referred to third words. The third words collectively form a third text. FIG. 9 is a screenshot showing the third text. In an embodiment, the arrangement shown in FIG. 8 and the attachment of the hashtag shop in FIG. 9 may be processed as shown in Table 3.

TABLE 3
1. Use the programming function ″ $fr = str_replace(′ ′, [symbol] r [symbol] n′,$fr); ″ to jump a
margin to the next line.
2. Use the programming function ″ $txt_result = array_unique($txt_ori); ″ to
remove duplicate words.
3. Use the programming function ″$arr = explode(″ [symbol] r [symbol] n″, $str);foreach ($arr as
$line_num => $line) { $line = ″#″.$line;} ″ to insert the hashtag identifier ″#″ in
front of the secod words.

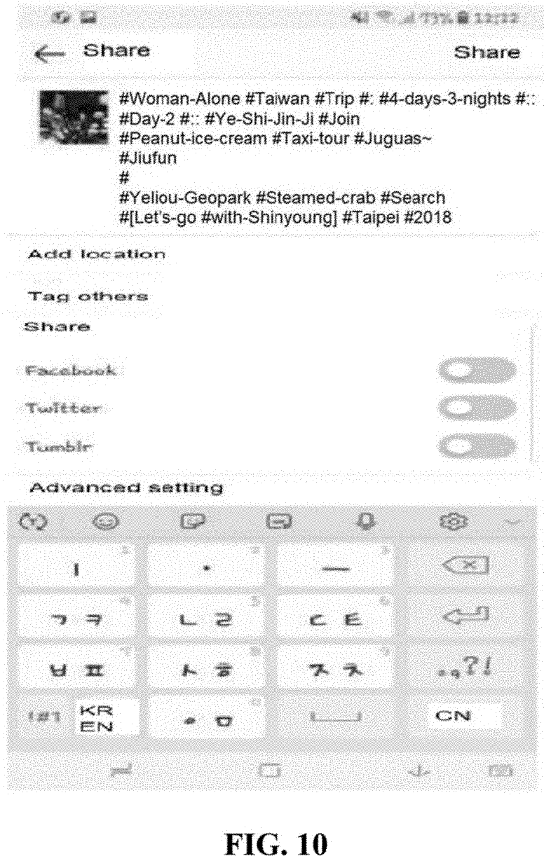

Next, the server transmits the third text, which is integrated with the hashtag, to the application of the user terminal. The third text is displayed in connection with the first content, generating a third content. FIG. 10 is a screen showing the third content, e.g., an image. The third content is automatically generated by integrating the first image and the third text. As a result, the first content integrated with the third text is displayed on the user terminal screen.

In an embodiment, the application provides“X” boxes for words included in the second text or included in the third text so that the user can remove unwanted words. In addition, the application allows a user to add desired words through an input window. See FIG. 10. The application may be designed to provide various types of text input functions so that addition of desired words is capble.

Next, as shown in FIG. 10, the present invention allows the user to upload and share the third content, i. e., the first content integrated with third text, on social media, such as Facebook, Twitter, Tumblr, etc. Due to the third text, the chance of exposure increases. According to the present invention, words commonly used in search engines ire relation to the first content can be easily borrowed, can be integrated with the first content, and displayed on the application. The present invention automatically extracts and suggests search keywords that a user might not able to come up with. Accordig to the present invention, it is easy to locate and attach proper keywords, making effective search allowable for the first content.

According to the present invention, foreign language keywords can be easily located, extracted, and integrated with the first content, thus maximizing chance of exposure. It is possible to add keywords at user's disposal to further increase the chance of exposure. The method according to an embodiment of the present invention can be summarized as follows.

With the method, search keywords can be automatically inserted into and attached to a given content along with a special identifier. The method includes: in response to transmission of a first content from a user terminal to a server via an application, transmitting the first content from the server to a search engine, wherein the application is installed on the user terminal and linked with the server; searching a second content using the search engine, wherein the second content has a predetermined degree of similarity to the first content, wherein the number of the second content is one or more; extracting and copying a first text from the second content and storing the first text in the server; generating, in the first server, a first tact file for the first text; arranging first words, which are included in the first text, line by line using a margin to generate a second text, wherein the number of the first words is one or more; removing one or more duplicate word from second words included in the second text and attaching a special identifier to each of remaining second words to generate a third text; and in response to transmission of the third text from the server to the application installed on the user terminal, displaying the first content integrated with the third text on the user terminal.

As described above, the present invention is basically performed by data exchange between (i) an application installed on a user terminal, (ii) a server linked to the user terminal and (iii) a search engine linked with the server. According to the present invention, search keywords are automatically inserted into or attached to a given content. Thus, a user who wants to upload the given content does not need to manually enter or attach search keywords to the given content. Compared with a conventional application, the application employing the present, invention is advantageous in automatically enhancing convenience and chance of exposure to search.

In the above description, the hashtag is presented with the symbol “#”, but is not limited thereto. In another embodiment, other symbols and special identifiers such as “!”, “@”, “#” “$”, “%”, “\hat{ }”, “′”, “*”, etc. may be used as the hashtag. In the present invention, it should be understood that any symbol or special character can be employed to represent a hashtag.

What is claimed is:

1. A method for automatically inserting a keyword for searching content with a special identifier, comprising:
in response to transmission of a first content from a user terminal to a server via an application, transmitting the first content from the server to a search engine, wherein the application is installed on the user terminal and linked with the
searching a second content using the search engine, herein the second content has a predetermined degree of similarity to the first content, wherein the number of the second content is one or more;
extracting and copying a first text from the second content content and storing the first text in the server,
generating in the first server, a first txt file for the first text;
arranging first words, which are included in the first text, line by line using a margin to generate a second text, wherein the number of the first words is one or more;
removing one or more duplicate word from second words included in the second text and attaching a special identifier to each of remaining second words to generate a third text; and
in response to transmission of the third text from the server to the application installed on the user terminal, displaying the first content integrated with the third text on the user terminal.
